(19) United States
(12) Patent Application Publication
(10) Pub. No.: US 2008/0004795 A1
(43) Pub. Date: Jan. 3, 2008

(54) System and method to locate a destination on an electronic map and to provide information thereof

(76) Inventor: Ho Shing Billy PUN, Hong Kong (HK)

Correspondence Address: KEVIN J. MCNEELY, ESQ., 5335 WISCONSON AVENUE, NW, SUITE 440, WASHINGTON, DC, 20015, US

(21) Appl. No.: 11/766,472

(22) Filed: Jun. 21, 2007

(30) Foreign Application Priority Data
Jun. 23, 2006 (HK) 06107165.8

(51) Int. Cl. G01C 21/00

(52) U.S. Cl. 701/200

(57) ABSTRACT

The present invention discloses a method to locate a destination on an electronic map and to provide information thereof, comprising the operations of: (a) defining an area on the electronic map for locating the destination; (b) displaying at least one business category for selection; (c) displaying in a group at least one icon associated with a business provider in a selected category for selection; and (d) indicating at least one icon associated with a selected business provider at the corresponding location of the business provider on an area map of the area defined. The user may locate a destination of a business provider without knowing the address of the destination or the exact business provider in mind.

### TECHNICAL FIELD

The present invention relates generally to a method for locating a destination on an electronic map. In particular, the present invention relates to a map with respect to an area covered by a mass transport railway system, such as, a subway or a train system.

### BACKGROUND

A conventional electronic map usually provides a function for the user to input an address, for example, a road name or a building name, as a search criteria for locating the destination. However, if the user wants to find the location of a specific restaurant or shop, he must first find out the address of the restaurant before using the electronic map.

In addition, this kind of map only shows one target destination at one time. It does not give other options of similar shops near by the location of the user. The information provided by the map is limited to the target destination input by the user. If the user wants to locate a specific type of restaurant, for example, a Japanese restaurant in an area without any specific restaurant in mind, the above map simply does not help at all.

The above map also fails to provide other additional information about the destination, for example, the telephone number of the business provider, the opening hours, the physical appearance of the venue, the recommended goods or services, and any discount available.

There are other electronic maps, for example, www.maps.yahoo.com which allow the user to type in a business category to display a map that automatically shows a list of the business providers in the area, and the corresponding locations on the map. However, the user has to guess the names of the categories which are available. The user may have to try different names of business categories a few times before hitting the correct category name.

Although the above map provides some categories for the user to choose from after the user has specified an area to do the search in, once a category is selected, a long list of the business providers under the category is provided. If a business provider has more than one branch location in the area, more entries will be listed for selection. This is quite common if the business provider is a franchise store or a chain store. Even if the user is not interested in that business provider, those additional branch locations in the area are displayed anyway, which makes it inconvenient for the user to reach the business provider he desires. The user has to scroll down a long list of business names to select his destination. Sometimes the user has to scroll back upward to view the business names previously shown. It may be more convenient if a better layout of the business providers is provided for the user to select from.

It is also difficult for the user to specify an area for the search. If too large an area is defined, the search will generate a long list of business names. The user often has to adjust the area a few times before reaching an optimal size of area for conducting the search. It is even more difficult if the user is not familiar with the area.

Another restriction of the above electronic maps is that only the business providers at the selected area will be shown. There may be other branch locations of the same business provider outside the selected area which are not shown. In some cities of high population density, such as Hong Kong, London and New York, it is not unusual that the user may want to go to a nearby area for dining or shopping, and it is convenient to do so, especially if the areas of the city are connected by mass transport railway systems. Existing electronic maps typically do not indicate the locations of the other branches of the business provider in a user-friendly and convenient manner.

Cities of high population density are usually well connected by mass transport railway system, which is the most common transportation means for residents and for tourists. The subway or the train system is the most popular transportation means that people use when going out for dining or shopping. People are more keen to reach their destination by subway or train. However, existing electronic maps are not tailored for such transportation practice. The electronic map may be more convenient if the user can easily find out how to go to a specific railway station, that is, knowing what route to take and where to interchange, and what shops, dining places or facilities are around the station.

It is therefore obvious that there is a need for an improved method to locate a destination on an electronic map to overcome all or some of the problems described above.

### SUMMARY OF THE INVENTION

The object of the present invention is to locate a destination on an electronic map and to provide information thereof.

In accordance with the present invention, there is provided a method comprising the operations of:
(a) defining an area on the electronic map for locating the destination;
(b) displaying at least one business category for selection;
(c) displaying in a group at least one icon associated with a business provider in a selected category for selection; and
(d) indicating at least one icon associated with a selected business provider at the corresponding location of the business provider on an area map of the area defined.

In one embodiment of the present invention, the user may locate a destination without knowing the address of the destination.

In another embodiment of the present invention, the user may locate a destination of a business provider without the exact business provider in mind.

In another embodiment of the present invention, the user is provided with railway stations for selection in order to define an area on the electronic map for locating a destination.

In another embodiment of the present invention, the user is provided with a display of a railway map for the selection of a station.

In another embodiment of the present invention, the user is provided with districts for selection in order to define an area on the electronic map for locating a destination.

In another embodiment of the present invention, the user is provided with a display of an area map around a selected station or a selected district.

In another embodiment of the present invention, the user is provided with a display of an area map substantially centered on a selected station.

In another embodiment of the present invention, the user is provided with at least one business category for selection.

In another embodiment of the present invention, the user is provided with at least one sub-business category for selection.

In another embodiment of the present invention, the user is provided with at least one icon associated with the business providers of a selected category in a group for easy selection.

In another embodiment of the present invention, only one icon of the business provider is available for selection even if there is more than one location of the same business provider on the area map to avoid a long list of the various locations of the business provider for selection, wherein after selecting the icon, the user is further provided with the various locations of the business provider for selection.

In another embodiment of the present invention, the user is provided with the locations of other business providers under the same business category or sub-business category on an area map, in addition to the business provider selected.

In another embodiment of the present invention, the user is provided with the branch locations of the selected business provider outside the area map.

In another embodiment of the present invention, the user is provided with the information of the selected business provider in the form of text, graphics, photographs or video.

In another embodiment of the present invention, the user is provided with the information of the selected business provider in form of a video displaying a 360° view in the venue of the selected business provider.

In another embodiment of the present invention, the user is provided with the information of the selected business provider in the form of a discount coupon. In another embodiment, the present invention is applicable on a PDA or a smart phone.

### BRIEF DESCRIPTION OF DRAWINGS

The above and other aspects, features, and advantages of the present invention will become more apparent upon consideration of the following detailed description of preferred embodiments, taken in conjunction with the accompanying drawing figures, wherein:

FIG. 1 illustrates the main algorithm in accordance with an embodiment of the present invention;

FIGS. 2a-2d illustrate the detailed algorithm in accordance with an embodiment of the present invention;

FIGS. 3a-3g are the screen display of the Level 1 page on a computer in accordance with an embodiment of the present invention applied via the Internet;

FIGS. 4a-4c are the screen display of the Level 2 page on a computer in accordance with an embodiment of the present invention applied via the Internet;

FIGS. 5a-5f are the screen display of the Level 3 page on a computer in accordance with an embodiment of the present invention applied via the Internet;

FIGS. 6a-6i are the screen display of the Level 4 page on a computer in accordance with an embodiment of the present invention applied via the Internet;

FIGS. 7a-7d illustrate the detailed algorithm in accordance with an embodiment of the present invention;

FIGS. 8a-8p are the screen display of the pages on a PDA in accordance with an embodiment of the present invention.

### DETAILED DESCRIPTION OF THE INVENTION

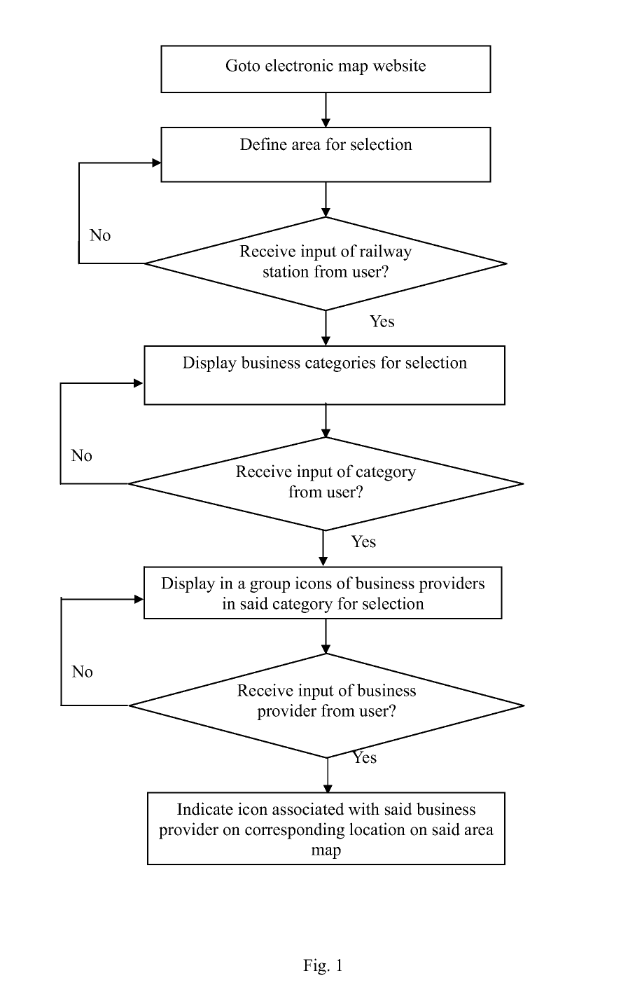

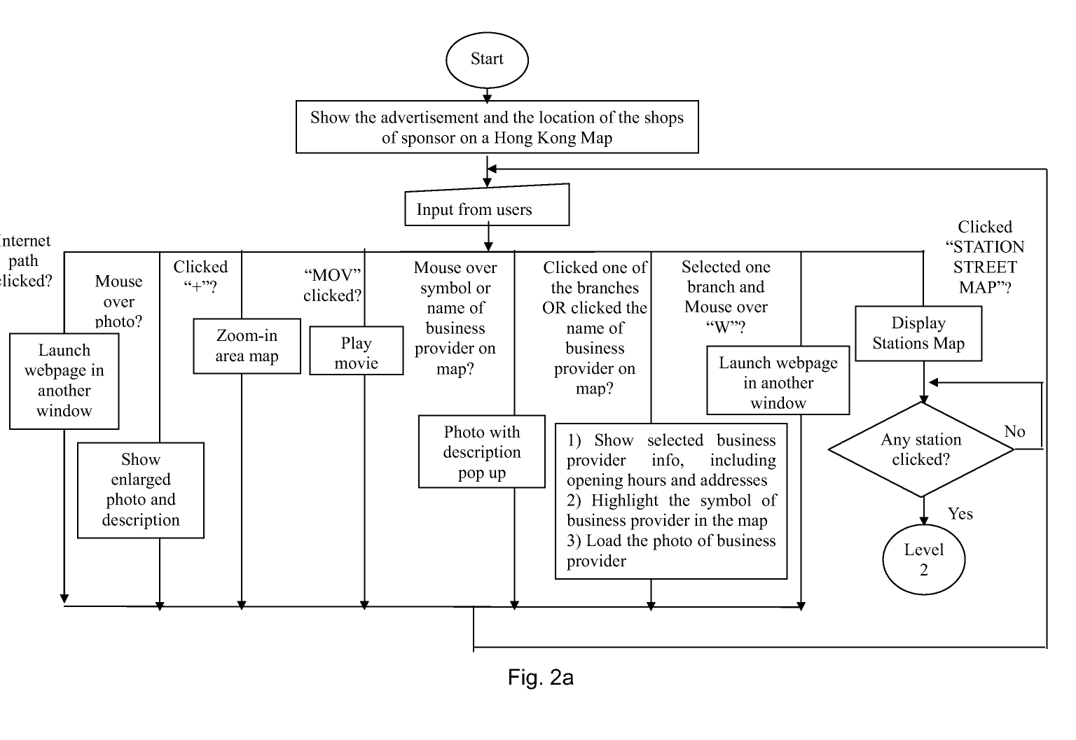

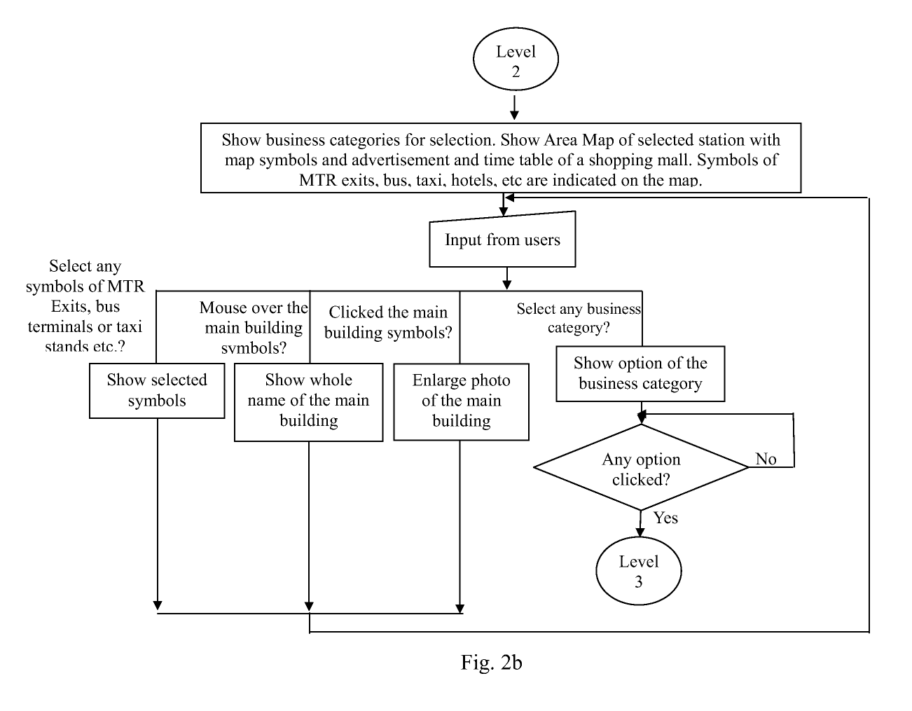

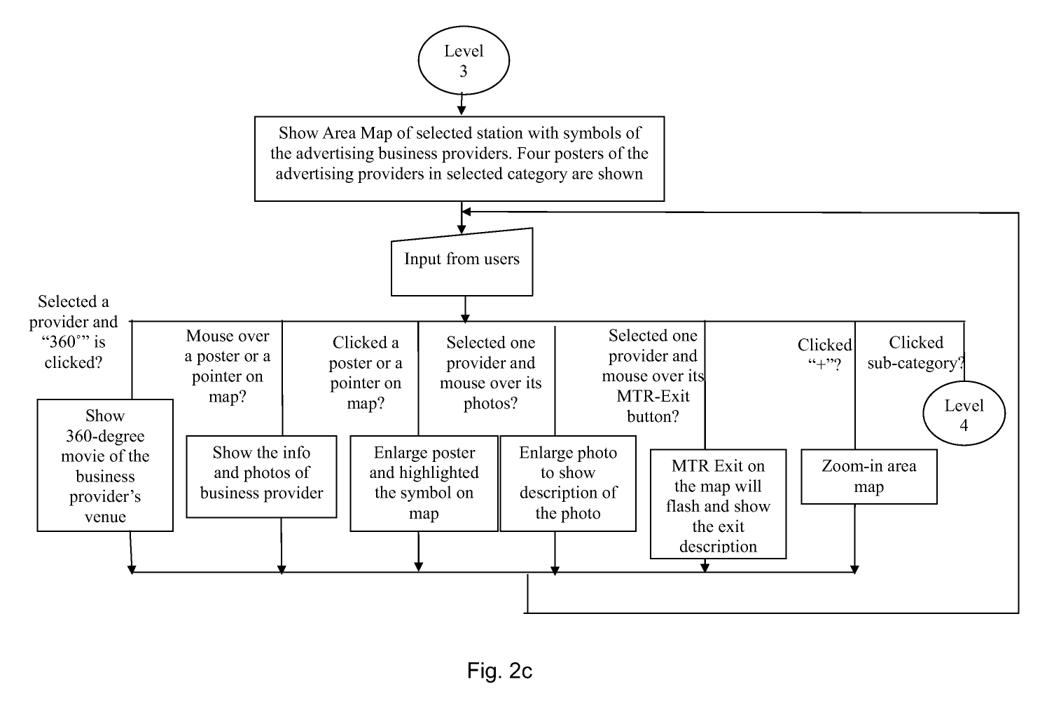

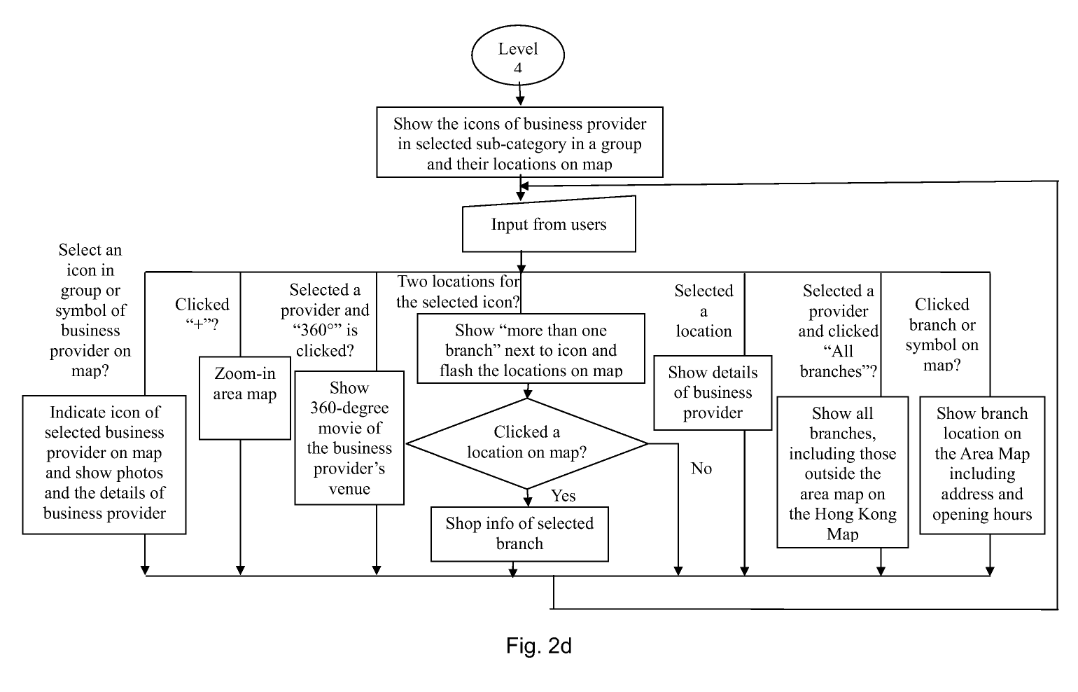

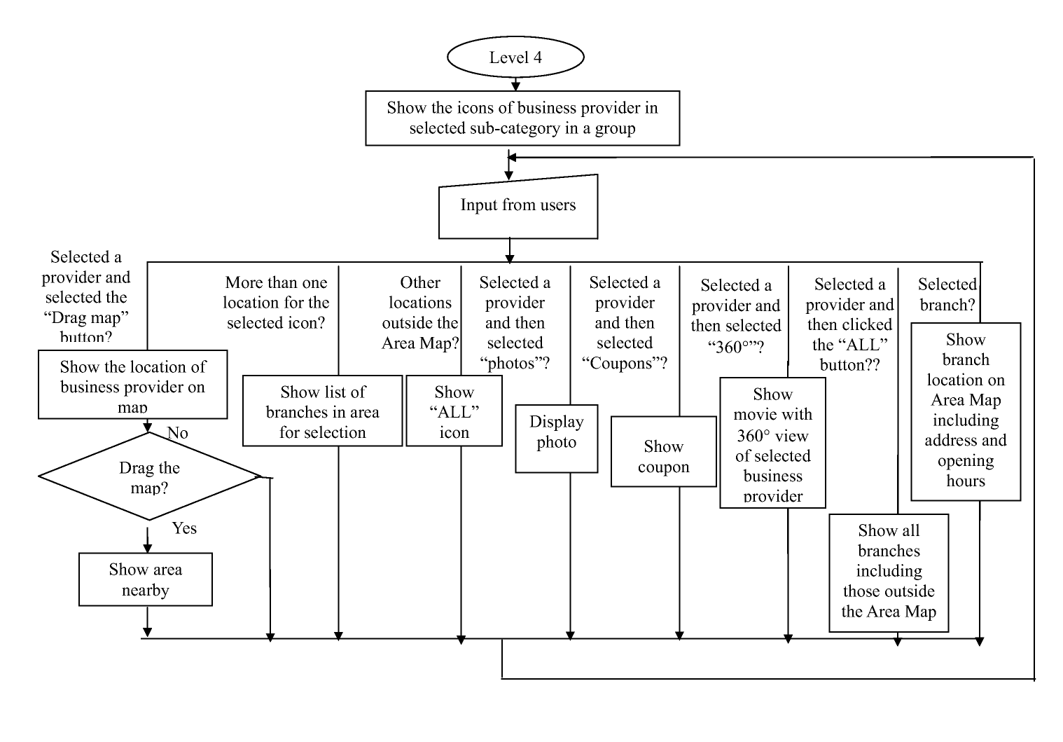

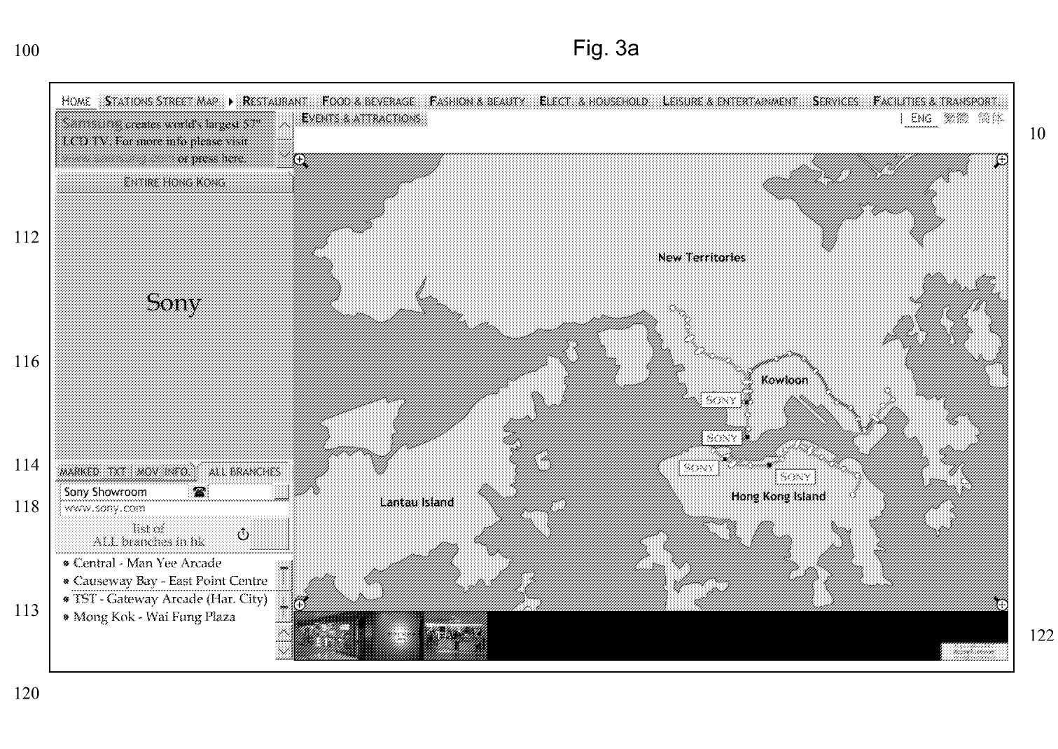

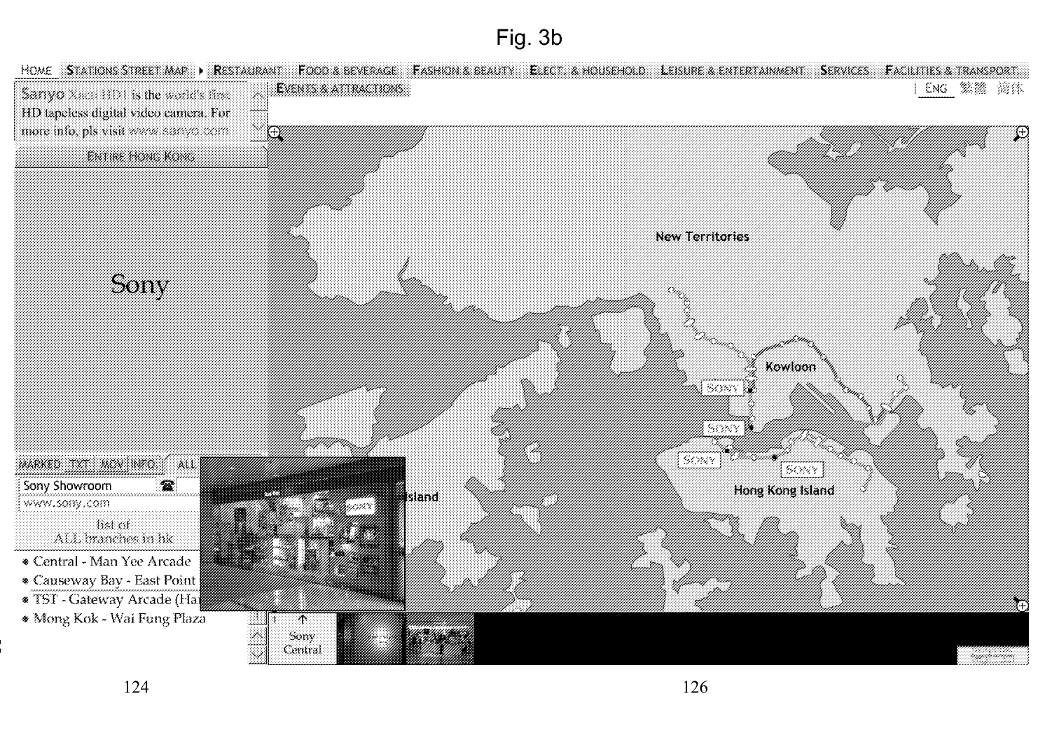

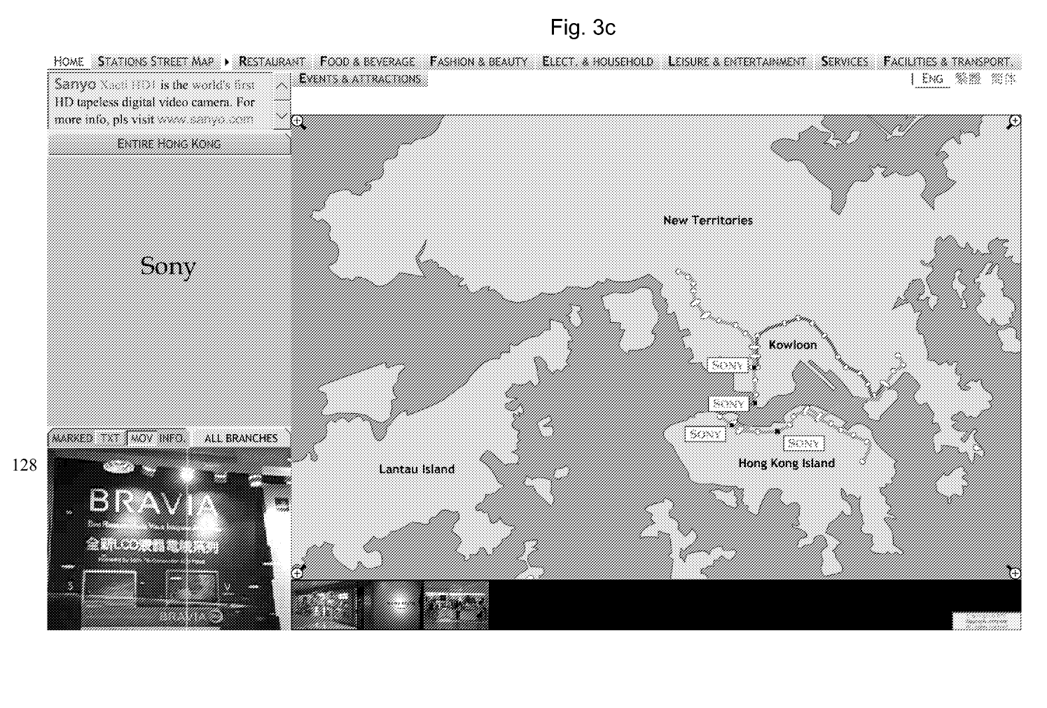

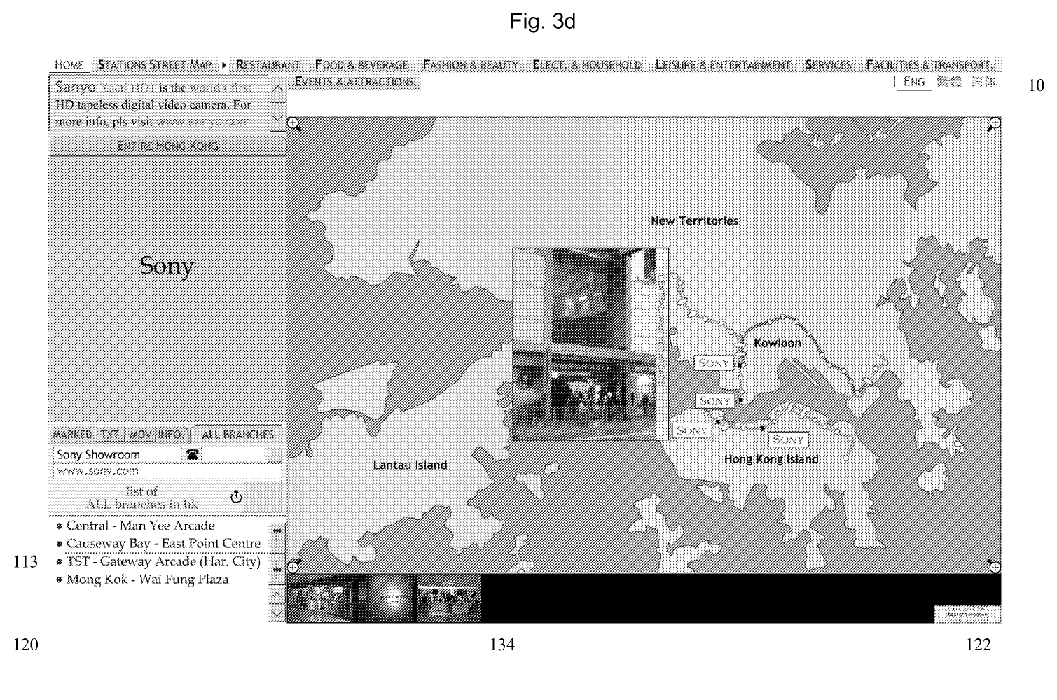

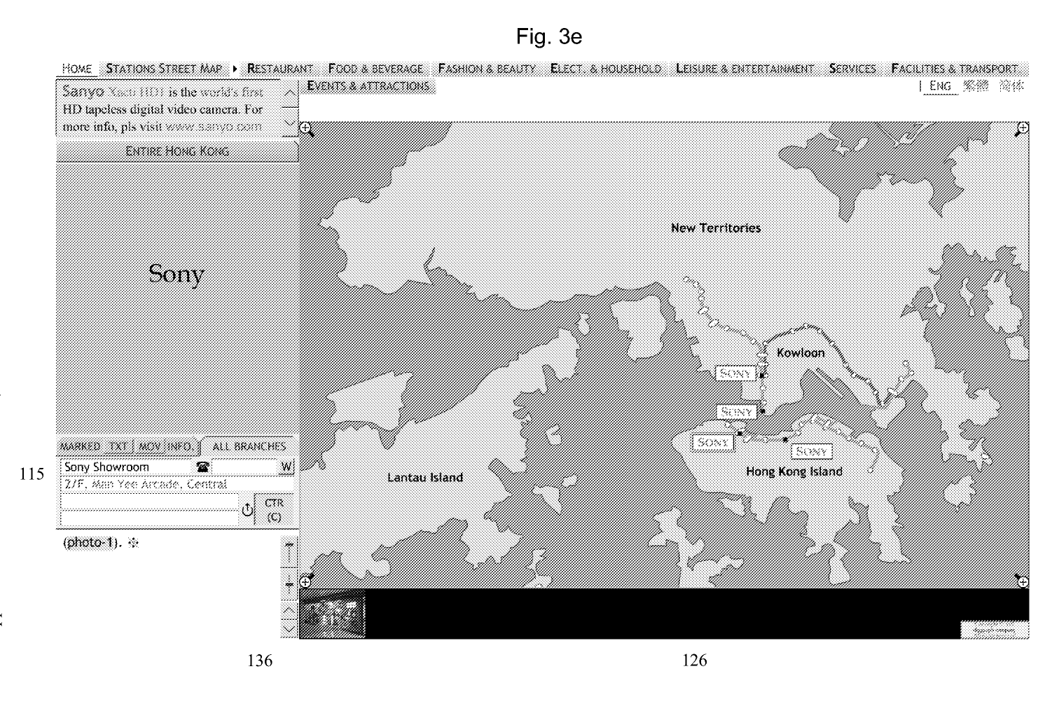

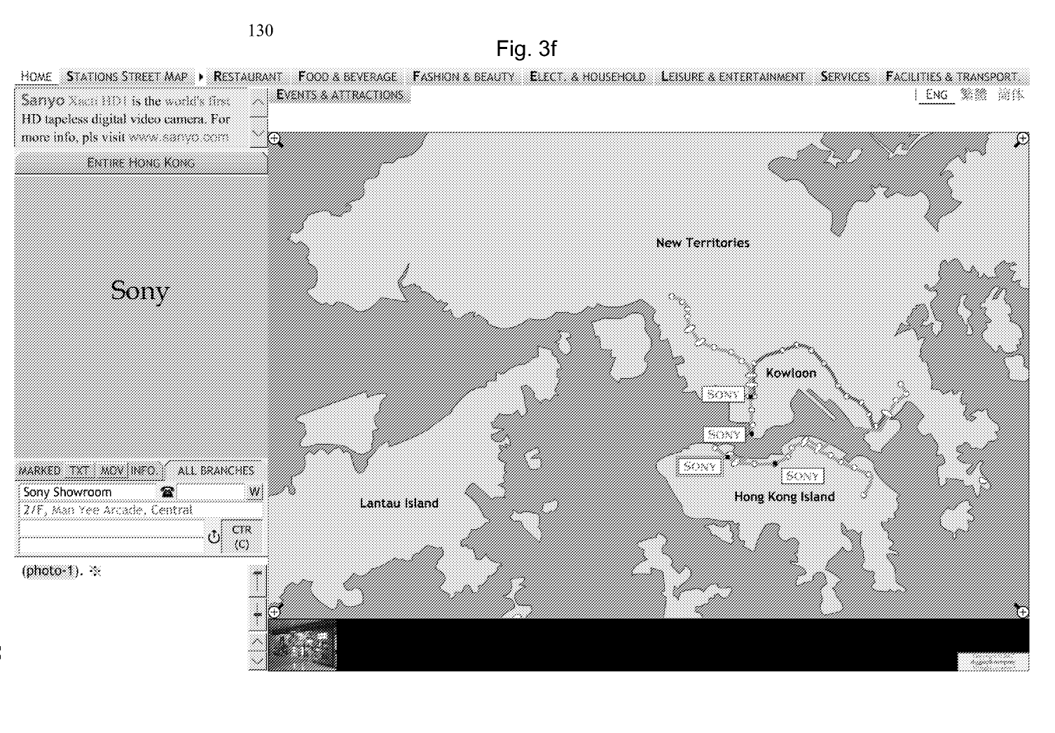

An embodiment of a Hong Kong electronic map available on the Internet is used to illustrate the present invention. The algorithm of this embodiment is illustrated in FIGS. 1 and 2a-2d. In this embodiment, as illustrated in FIGS. 3a-3g, when entering the web-site of the electronic map, a Level 1 page [100] containing a Hong Kong Map [10] covering the whole Hong Kong area will first be displayed to the user.

As shown in FIG. 3a, Level 1 page [100] may also display the advertisement of a business provider in box [112] and the details of the advertising business provider, such as the company name [114], the telephone number [116], the website [118] and the available branches [120] in box [113]. Level 1 page [100] may provide a hyperlink to the website [118] of the advertising business provider. The locations of the branches are displayed on the Hong Kong Map [10] by symbols [122] representing the advertising business provider.

As shown in FIG. 3b, Level 1 page [100] may display a number of photographs of the advertising business provider in box [126]. When the user moves a mouse over the photograph [124], the photograph [124] will be enlarged and the description of the photograph [124] will be shown.

As shown in FIG. 3c, a button MOV [128] is provided for displaying a movie provided by the advertising business provider.

As shown in FIG. 3d, the user may mouse over the symbol [122] to display a photograph [134] of that location.

As shown in FIGS. 3d and 3e, if the user clicks on an available branch [120] in box or the symbol [122] on the Hong Kong Map [10], the detailed information such as the address and the opening hours of the branch will be displayed in box [115]. A number of photographs [136] of the branch may be displayed in box [126].

As shown in FIGS. 3f and 3g and as illustrated in Operation (a), the user may click the STATION STREET MAP button [130] to display the Stations Map [20] which shows all subway and train stations [132] in Hong Kong. If the station is an inter-change station, the relevant routes will be shown when the user mouse over the station [132]. The user may select map area he is interested in by clicking a station [132]. In addition, some popular districts not near to the stations, but are popular areas where users are usually interested in, such as the district of the Peak area in Hong Kong, may be available for selection. An area map has been assigned to each railway station or district available for selection. The selection of a railway station or a district defines the area in which the destination is to be located. By way of example, the user selects Central station.

As shown in FIG. 4a, a Level 2 page [200] displays an Area Map [30] around the selected station. The Area Map [30] may be centered on the selected station. A box [201] at the top left corner of the Area Map shows the name of the selected station. The information or the advertisement of a popular shopping mall in the area may be displayed in box [202]. A number of the photographs [204] of the shopping mall may be displayed in box [206].

The location of the main buildings is also displayed by symbols [207] on the Area Map [30]. As shown in FIGS. 4b and 4c, the user may mouse over the symbol to show the name of the main building, or click the symbol [207] to see a photograph of the main building.

As shown in FIG. 4a, the Area Map [30] is substantially centered on the selected station and shows all the exits [208] of the station. In one embodiment, an arrow indicates the direction of each exit [208], to make it easier for the user to select the nearest exit to a location.

A box [211] is provided at the top right corner of the Area Map [30] for the user to select to locate the stations of other transportation, for example the bus terminal and the taxi stand, or other facilities such as the car park and the post office on the Area Map [30].

As illustrated in Operation (b), a list of business categories [212] is shown on top of the Area Map [30], for example, RESTAURANT, FASHION & BEAUTY, ELECT & HOUSEHOLD. Each business category [212] contains a further list of selection under the business category, for example, “CHINESE (GUANGDONG)”, “ASIAN COUNTRIES”, and “EUROPEAN (WESTERN”). The user may select a business category for the location he is looking for. By way of example, the user selects “CHINESE (GUANGDONG)” under “RESTAURANT”.

As shown in FIG. 5a, the user enters a Level 3 page [300]. On top of the Area Map [30], a list of the sub-business categories [302] under the business category of RESTAURANT CHINESE (GUANGDONG), for example, “cuisine/dim-sum/hot-pot”, “home-style”, “localize rest./noodle+congee”, are available for selection. In a box [304], the advertisements of the business provider in the sub-business categories [302] are displayed. By way of example, the box [304] displays four photographs [305] of the advertising restaurants. The locations of the four advertising restaurants are also displayed on the Area Map [30] indicated by a graphical symbol or a text symbol [306] representing the advertising restaurant. A message “select recommended Guangdong food rest.” is displayed in box [303] to urge the user to select the advertising restaurant.

As shown in FIG. 5b, when the user moves the mouse over a restaurant photograph [305] in box [304], the symbol [307] representing the selected restaurant at the location of the restaurant may be highlighted on the Area Map [30]. A box at the bottom right corner of the Area Map [30] shows the date the location was last updated. The information related to the selected restaurant such as the name, the telephone number, the address and the opening hours of the restaurant may be displayed in box [308]. A number of photographs [310] related to the selected restaurant may be displayed in box [312]. The sub-business category [314] to which the selected restaurant belongs will be indicated.

As shown in FIG. 5c, the photograph [305] of the advertising restaurant will be enlarged if the user clicks the photograph [305]. The symbol [307] representing the selected restaurant at the location of the restaurant may be highlighted on the Area Map [30].

As shown in FIG. 5d, when the user moves the mouse over the photograph [310] of the selected restaurant in box [312], the photograph [310] will be enlarged and the description of the photograph [310] will be shown.

As shown in FIG. 5e, a button [313] in box [308] shows the name of the subway station exit nearest to the selected restaurant. The location of the exit will be indicated on the Area Map [30].

The user may click one of the buttons [316] at the corners of the Area Map [30] to zoom in the Area Map [30]. As shown in FIG. 5f, a zoom-in map [40] covering the selected restaurant is displayed.

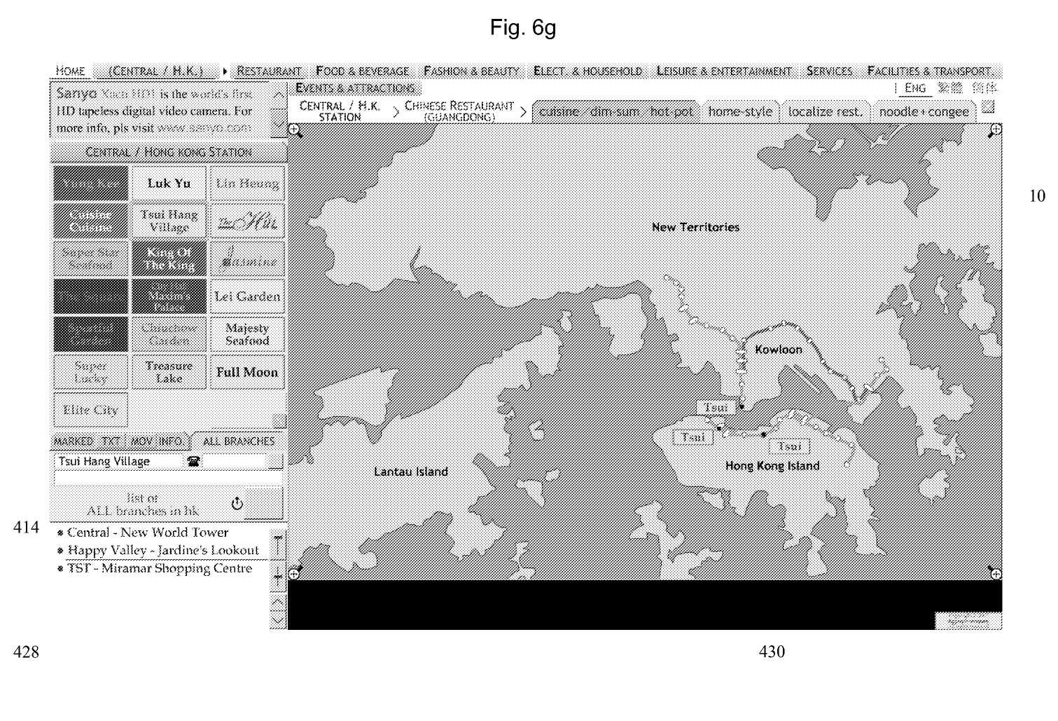

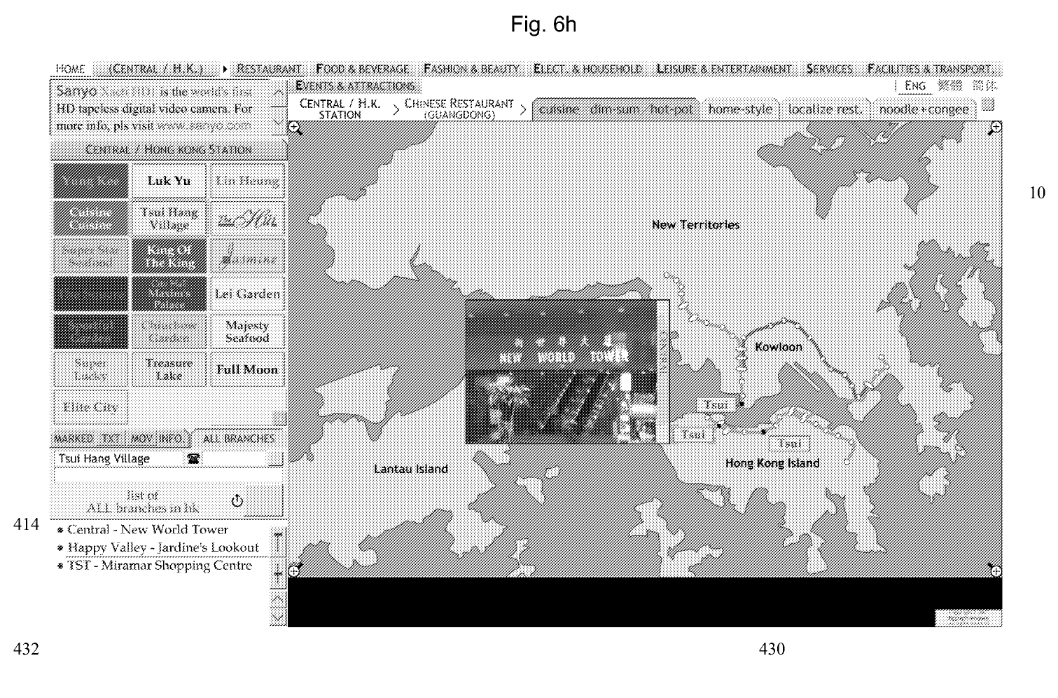

As shown in FIG. 6a, the user may select a sub-business category [302] he desires. By way of example, “cuisine/dim-sum/hot-pot” is selected. As illustrated in Operation (c), a Level 4 page [400] is displayed showing a group of icons [402] associated with the business providers in the sub-business category, for example, the restaurants, which provide “cuisine/dim-sum/hot-pot”. The icons may be trademarks, text or graphical symbols, or logo representing the restaurants. By way of example, the icons [402] are arranged in a group of 21 icons in a 7×3 table format, while the last icon [404] may be used to indicate there is a next page of icons [402] for selection. A message in box [406] prompts the user to select a restaurant he desires. The locations of the restaurants represented by the icons [402] are shown on the Area Map by symbols [408] which may be names, trademarks, or logo of the restaurants.

As shown in FIG. 6b, when the user moves the mouse over an icon [402], a number of photographs [410] related to the selected restaurant is displayed in box

. As illustrated in Operation (d), the symbol of the selected restaurant [413] may be highlighted in the Area Map [30].

The details of the selected restaurant, such as the name [416], the telephone number [418], and the address [420] are shown in box [414].

As shown in FIG. 6c, the user may click a button “360°” [422] for the display of a movie showing a 360° view in the restaurant provided by the selected restaurant in box [414].

As shown in FIG. 6d, if the selected restaurant has more than one branch location in the Area Map [30], a message [426] “more than one branch” will be displayed at the selected icon [424]. The brief location of the branches of the selected restaurant will be shown in box [414]. The symbols [427] indicating the branch locations will be highlighted on the Area Map [30].

As shown in FIG. 6e, when the user clicks the symbol [429] of a particular branch location on the Area Map [30], the information related to the branch will be displayed in box [414].

As shown in FIGS. 6f and 6g, if the selected restaurant has other branch locations outside the Area Map [30], a button “ALL BRANCHES” [428] may be displayed to inform the user. If the user clicks the button “ALL BRANCHES” [428], a list of the locations will be shown in box [414]. The Hong Kong Map [10] will be displayed showing the symbols [430] indicating the branch locations of the selected restaurant.

As shown in FIGS. 6h and 6i, the user may mouse over the symbols [430] to display a photograph of that location. If the user clicks on an available branch [432] in box [414] or the symbols [430] on the Hong Kong Map [10], the detailed information such as the address and the opening hours of the branch will be displayed in box [414]. The user may also select to view the branch location on the Area Map [30].

In another embodiment, the present invention is used on a PDA or a smart phone. The algorithm of this embodiment is illustrated in FIGS. 1 and 7a-7d. As the display screen is limited in size, some functions in the Internet version are modified. As shown in FIGS. 1, 7a and 8a and as illustrated in Operation (a), a Level 1 (PDA) page [500] allows a selection of a subway or a train station under box STN [502], instead of displaying the Stations Map [20] in the Internet version.

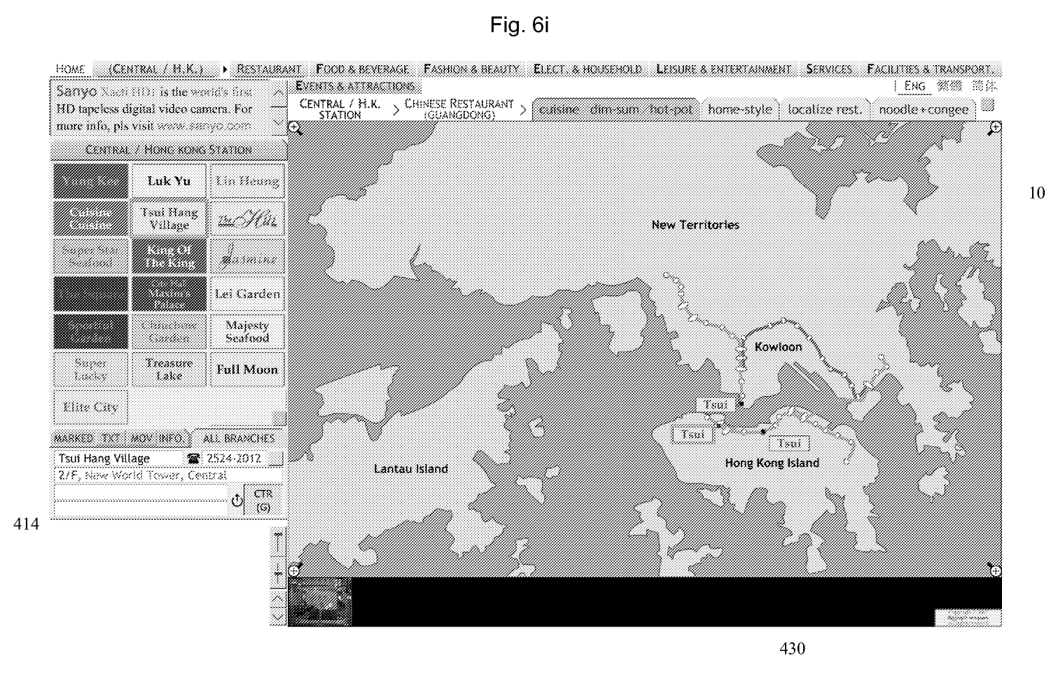

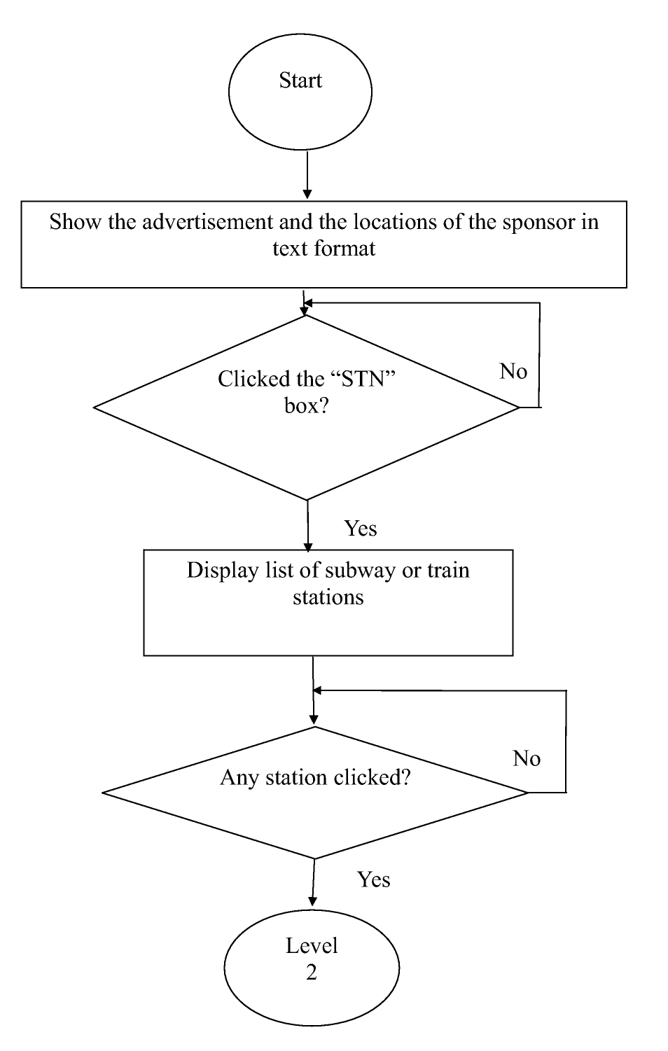

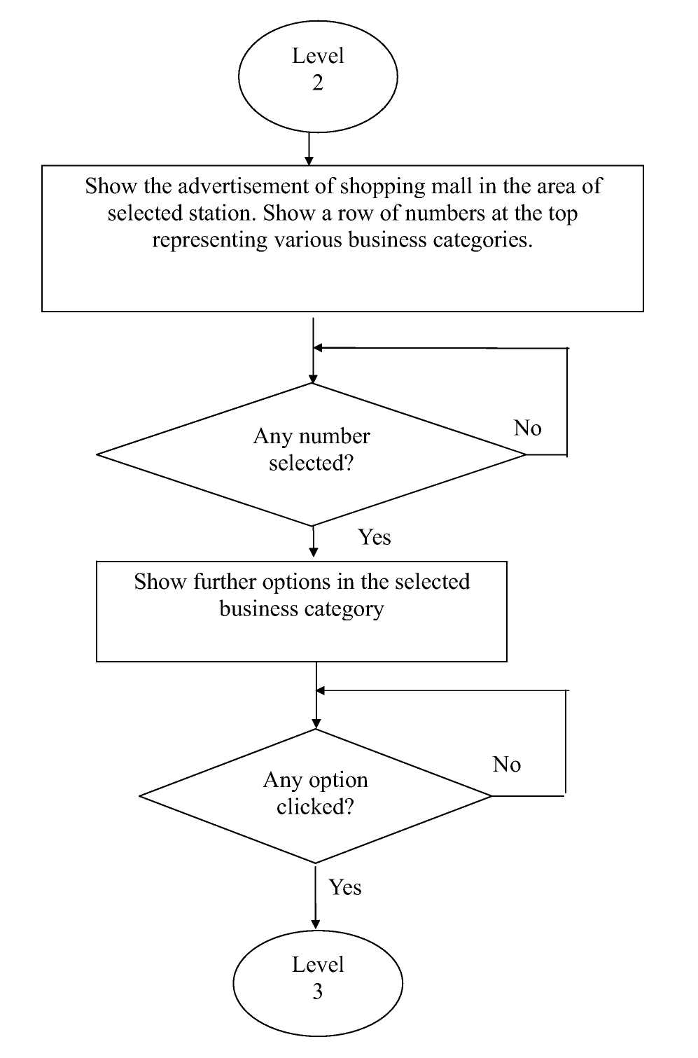

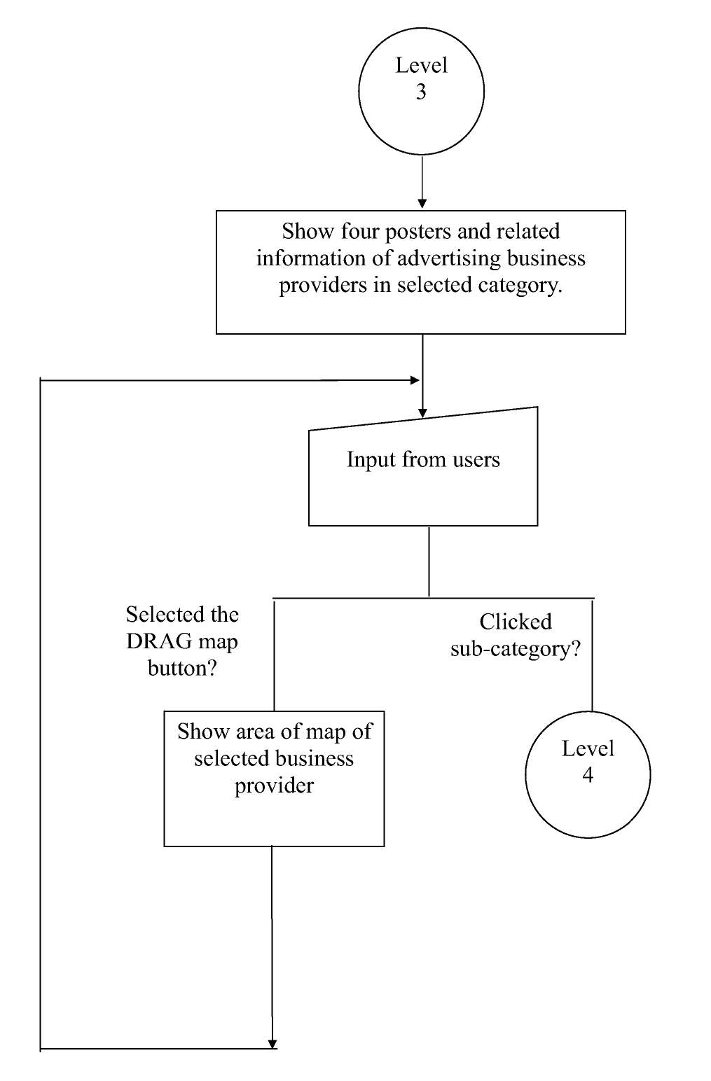

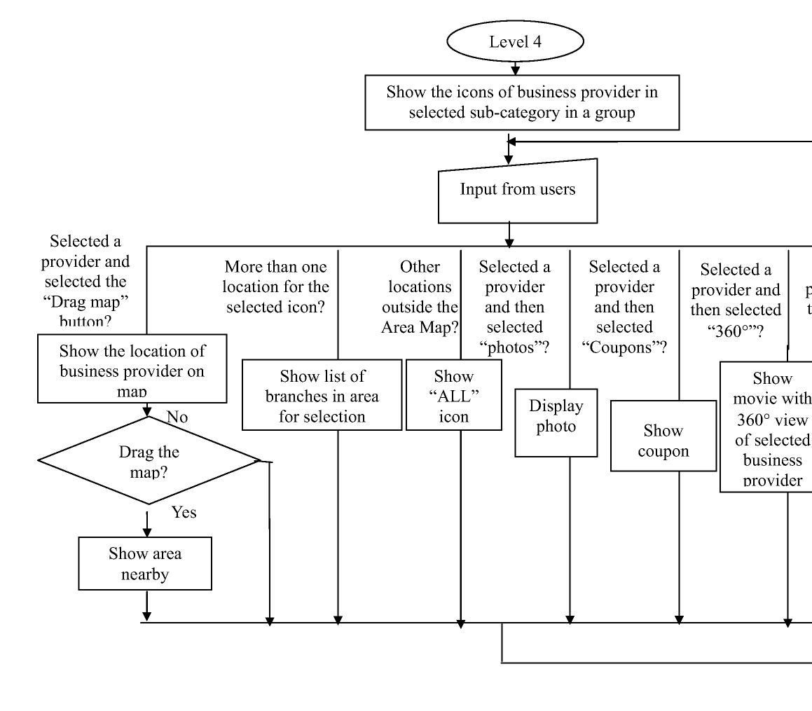

As shown in FIGS. 7b and 8b, after electing a station, the user enters into a Level 2 (PDA) page [600] displaying an advertisement [602] of a popular shopping mall in the area of the selected station. As illustrated in Operation (b), a row of numbers [604] at the top of the screen represents various business categories. As shown in FIG. 8c, by way of example, the user selects RESTAURANT—CHINESE (GUANGDONG).

As shown in FIGS. 7c, 8d and 8e, the user enters into a Level 3 (PDA) page [700]. In box [702], the advertisements of the business providers in the selected business category are displayed. In box [704], the information related to advertising business provider, for example, the name, the telephone number, the address and the opening hours are displayed. The user may select a button DRAG MAP [706] to view an Area Map of the selected restaurant.

As shown in FIG. 8f, the user may select a sub-business category, for example, “cuisine/dim-sum/hot-pot”, “home-style”, “localize rest./noodle+congee”, under the selected business category RESTAURANT—CHINESE (GUANGDONG).

As shown in FIGS. 7d and 8g, and as illustrated in Operation (c), a Level 4 (PDA) page [800] is displayed showing a group of icons [802] associated with the business providers in the sub-business category, for example, the restaurants, which provide “cuisine/dim-sum/hot-pot”. The icons may be trademarks, text or graphical symbols, or logo representing the restaurants. By way of example, the icons [802] are arranged in a group of 20 icons in a 5×4 table format.

As shown in FIG. 8h, a message in box [806] prompts the user to select a restaurant he desires. As shown in FIG. 8i, the information related to the restaurant of the selected icon [802] is displayed in box [804].

As shown in FIG. 8j and as illustrated in Operation (d), after selecting the button DRAG MAP [808], the location of the restaurant represented by the selected icon is shown on the Area Map [90] by symbol [810] which may be names, trademarks, or logo of the restaurant. The user may further drag the Area Map [90] around to show other areas nearby.

As shown in FIG. 8k, if the selected restaurant has more than one location on the Area Map [90], the locations will be displayed in box [804] for selection.

As shown in FIG. 8l, if the selected has other branch locations outside the Area Map [90], an icon “ALL” [812] will appear to indicate to the user that there exists other branch locations outside the Area Map [90]. After selecting “ALL”, all locations [814] will be displayed in box [804] for selection. After selecting a location [814] in box [804], as shown in FIG. 8m, the information related to the location [814], for example, the telephone number, the address, the opening hours and the nearest subway or train station exit will be shown in box [804]. The user may also select to view the location [814] on the Area Map [90].

As shown in FIG. 8n, the user may select “photo 1” on box [804] to view a photograph [816] of the selected restaurant. As shown in FIG. 8o, the user may select “coupon 1” to view a coupon [818] of the selected restaurant. The user may save the coupon [818] for future use in the selected restaurant.

As shown in FIG. 8p, in the Level 4 (PDA) page, the user may select a button “360°” [820] for the display of a movie showing a 360° view in the restaurant provided by the selected restaurant.

Another embodiment may be provided on a stand-alone terminal to give map information in a subway or train station.

The embodiments of the present invention may be provided in multi-languages, for example, English, standard Chinese and simplified Chinese.

While the invention has been described in detail with reference to disclosed embodiments, various modifications within the scope of the invention will be apparent to those of ordinary skill in this technological field. It is to be appreciated that features described with respect to one embodiment typically may be applied to other embodiments.

What is claimed is:

1. A method to locate a destination on an electronic map and to provide information thereof, comprising:
(a) defining an area on the electronic map for locating the destination;
(b) displaying at least one business category for selection;
(c) displaying in a group at least one icon associated with a business provider in a selected category for selection; and
(d) indicating at least one icon associated with a selected business provider at the corresponding location of the business provider on an area map of the area defined;
such that a destination on the electronic map can be easily located.

2. The method as recited in claim 1, in operation (a), further comprising:
providing at least one railway station of a railway system related to the area for selection.

3. The method as recited in claim 2, in operation (a), further comprising:
displaying a railway map comprising the station.

4. The method as recited in claim 1, in operation (a), further comprising:
providing at least one district related to the area for selection.

5. The method as recited in claim 1, between operation (a) and step (b), further comprising:
displaying an area map of the area.

6. The method as recited in claim 1, in operation (c), wherein one icon is displayed for the business provider having more than one corresponding location on the area map.

7. The method as recited in claim 2, wherein the area map is substantially centered on the station selected.

8. The method as recited in claim 1, between operation (b) and operation (c), further comprising:
displaying at least one sub-business category under a selected business category for selection.

9. The method as recited in claim 1, in operation (c), wherein the icon comprises an advertisement of the business provider.

10. The method as recited in claim 1, after operation (c), further comprising:
displaying information related to a selected business provider.

11. The method as recited in claim 10, wherein the information is in at least one of a plurality of forms comprising: text, graphics, photographs and video.

12. The method as recited in claim 10, wherein the information is a video displaying a 360° view at the location.

13. The method as recited in claim 10, wherein the information is related to an exit of a railway station nearest to the location.

14. The method as recited in claim 10, wherein the information is a coupon of the business provider.

15. The method as recited in claim 1, in operation (d), further comprising:
displaying a zoom-in of the area map.

16. The method as recited in claim 1, in operation (d), further comprising:
displaying information related to at least one location of the business provider outside the area map.

17. The method as recited in claim 1, in operation (d), further comprising:
displaying at least one location of the business provider outside the area map.

18. The method as recited in claim 2, in operation (d), further comprising:
displaying a regional map of the whole region covered by the railway system and displaying at least one icon associated with the business provider at the corresponding location of the business provider on the regional map; and
displaying the corresponding location on a corresponding area map according to a selected location.

19. The method as recited in claim 1, wherein the icon comprises representation of the business provider of at least one of name, symbol and trademark.

20. The method as recited in claim 1, wherein the method is provided in a version of at least one language.

21. The method as recited in claim 1, wherein the method is applicable via at least one of a plurality of networks comprising: the Internet and the mobile network.

22. The method as recited in claim 1, wherein the method is used on at least one of a plurality of networks comprising: computer, terminal, PDA and smart phone.

23. A system to locate a destination on an electronic map and to provide information thereof, comprises:
an input device for defining an area on the electronic map for locating the destination;
a display device to display
at least one business category for selection;
at least one icon associated with a business provider in a selected category in a group for selection; and
at least one icon associated with a selected business provider at the corresponding location of the business provider on an area map of the area defined;
such that a destination on the electronic map can be easily located.

24. The system as recited in claim 23, wherein the display device further displays at least one railway station of a railway system related to the area for selection.

25. The system as recited in claim 24, wherein the display device further displays a railway map comprising the station.

26. The system as recited in claim 23, wherein the display device further displays at least one district related to the area for selection.

27. The system as recited in claim 23, wherein one icon in a group for selection is displayed for the business provider having more than one corresponding location on the area map.

28. The system as recited in claim 23, wherein the display device displays at least one sub-business category under a selected business category for selection.

29. The system as recited in claim 23, wherein the display device is configured to zoom-in on the area map.

30. The system as recited in claim 23, wherein the display device further displays at least one location of the business provider outside the area map.

31. The system as recited in claim 24, wherein the display device further displays:
a regional map of the whole region covered by the railway system and at least one icon associated with the business provider at the corresponding location of the business provider on the regional map; and
the corresponding location on a corresponding area map with respect to a selected location.
